(19) United States
(12) Patent Application Publication
(10) Pub. No.: US 2026/0316942 A1
(43) Pub. Date: Oct. 15, 2026

(54) ELECTRICAL POWER GENERATION AND DISTRIBUTION SYSTEM FOR AN AIRCRAFT, AND AIRCRAFT COMPRISING SUCH A SYSTEM

(71) Applicant: SAFRAN ELECTRICAL & POWER, Blagnac (FR)

(72) Inventors: Giovanni RAIMONDI, Moissy-Cramayel (FR); Philippe DELBOSC, Moissy-Cramayel (FR)

(21) Appl. No.: 18/998,779

(22) PCT Filed: Jul. 25, 2023
(86) PCT No.: PCT/FR2023/051159

§ 371 Date: Jan. 27, 2025

(30) Foreign Application Priority Data
Jul. 28, 2022 (FR) FR2207812

(51) Int. Cl. B64D 27/35; B64D 27/33; H02J 3/38; H02J 3/46

(52) U.S. Cl. CPC B64D 27/35; B64D 27/33; H02J 3/381; H02J 3/46; B64D 2221/00

(57) ABSTRACT

An electrical power generation and distribution system for a hybrid-electric propulsion aircraft powered by at least one turbojet engine. The system includes at least N≥2 (N integer) distribution networks, and at least M≥1 (M integer) generation channels associated with each distribution network. The electrical power supply parameters of the distribution networks are controlled by an electrical machine provided on each of the generation channels, on the basis of a generator control setpoint (Cg) defined by a common mode current IC resulting from the currents IN,M generated in the generation channels. The turbojet engine includes a high-pressure shaft, a low-pressure shaft and a control module for controlling the power transferred between the shafts on the basis of an engine regulation setpoint (Cm) defined by a differential mode current Id resulting from the distribution of power drawn between the generation channels.

### TECHNICAL FIELD OF THE INVENTION

The invention relates to the technical field of electrical power generation and distribution system for an aircraft.

The invention also relates to aircrafts comprising such systems. Such aircrafts are typically hybrid electric propulsion aircraft comprising a turbojet engine and at least one electrical machine operating in bidirectional mode to generate electrical energy from mechanical power drawn from the turbojet engine or to consume electrical energy to assist the turbojet engine so as to guarantee the stability of the mechanical-electrical system.

### TECHNICAL BACKGROUND

In traditional electrical power generation and distribution systems, electrical machines called generators are driven by a high-pressure body of the turbojet engine, and convert the mechanical power into electrical power to supply electrical loads on the aircraft. The generators are combined with servo-control modules to ensure the correct voltage and quality of electrical power from the network, whatever the current consumed.

The operating point of the turbojet engine is ensured by the thermodynamic design and by the good aerodynamic coupling between the high-pressure body and a low-pressure body of the turbojet engine. This ensures highly efficient thrust generation by transferring energy into a combustion chamber in the turbojet engine.

Efficiency has improved with the increase in the dilution ratio, i.e. the ratio between the mass of air in the cold stream and that in the lime stream, and with the introduction of optimised solutions for the combustion and air management, but the aerodynamic coupling between the two bodies introduces limitations and above all requires more precise regulation.

By electrically hybridizing the turbojet engine, the energy transfer between the high-pressure and low-pressure sections can be refined to improve efficiency at different operating points. This function involves the introduction of mechanically coupled electrical machines on the low-pressure body and the high-pressure body, which generate bidirectional energy exchanges that make the electrical system more complex.

Incidentally, this additional function of the electrical system introduces the challenge of ensuring sufficient independence between the servo-control of the turbojet engine and the servo-control of the aircraft's electrical distribution networks. The interaction between the electrical power extraction and the operating point of the turbojet engine is unavoidable, as the electrical energy is generated by extracting mechanical power from the turbojet engine.

Such a system is disclosed in the document WO 2016/020618, which describes an electrical power generation and distribution system for a hybrid electric propulsion aircraft. Said system comprising:
a turbojet engine powering the aircraft, said turbojet engine being equipped with a high-pressure rotation shaft and a low-pressure rotation shaft,
an electric engine capable of injecting mechanical power onto the high-pressure rotation shaft and/or the low-pressure rotation shaft,
a device for extracting mechanical power supplied by the high-pressure and low-pressure rotation shafts, said extraction device being capable of extracting mechanical power in excess of the mechanical power required for proper operation of the turbojet engine and of converting this excess mechanical power into electrical power so as to supply a means of storing the aircraft's electrical energy. Such a storage device can, for example, replace an aircraft electrical network.

An alternative would be to introduce a dedicated electrical generation system to supply power to the aircraft's networks, isolated from that for the turbojet engine's electrical assistance. However, this would make the aircraft even more complex, would increase the aircraft's weight and would not avoid the interaction between the electrical power draw-off and the turbojet engine's point of operation.

The documents FR3012796A1, FR3077804A1 and WO 2020/089544 A1 disclose electrical power generation and distribution systems for a hybrid electric propulsion aircraft. These systems comprise at least one turbojet engine comprising at least one high-pressure shaft, at least one low-pressure shaft, and a servo-control module capable of regulating a power transferred between the high-pressure shaft and the low-pressure shaft as a function of an engine regulation setpoint; at least one distribution network; and at least M generation channels associated with each distribution network. However, none of these documents discloses a system for generating and distributing electrical energy in which the engine regulation setpoint is defined by a differential mode current resulting from the dispatch of power drawn between the different generation channels, and, for each distribution network, the generator regulation setpoint is defined by a common mode current resulting from the currents generated in the generation channels of said distribution network.

The invention is designed to address the above issues.

### SUMMARY OF THE INVENTION

The invention allows the aforementioned disadvantages to be overcome and to this end proposes an electrical power generation and distribution system for a hybrid electric propulsion aircraft, said system comprising:
at least one turbojet engine comprising at least one high-pressure shaft, at least one low-pressure shaft, and a servo-control module capable of regulating a power transferred between the high-pressure shaft and the low-pressure shaft as a function of an engine regulation setpoint,
at least N distribution networks with N an integer greater than or equal to 2, and
at least M generation channels associated with each distribution network, with M being an integer greater than or equal to 1, each generation channel comprising an electrical machine driven by the high and low pressure shafts and capable of converting a mechanical power drawn from said high or low pressure shaft into an electrical power so that a current I_{N,M} is generated in each of the M generation channels of said distribution networks, each of said electrical machines being able to perform the servo-control of a power supply supplying the distribution networks as a function of a generator regulation setpoint,
the electrical power generation and distribution system being characterised in that the engine regulation setpoint is defined by a differential mode current resulting from the dispatch of power drawn between the various generation channels, and, for each distribution network, the generator regulation setpoint is defined by a common mode current resulting from the currents generated in the generation channels of said distribution network.

The invention thus allows the servo-control of the power transferred between the high-pressure shaft and the low-pressure shaft (hereinafter referred to as the servo-control of the turbojet engine) to be decoupled from the servo-control of the power supplied to the aircraft's distribution networks (hereinafter referred to as the servo-control of the distribution network of the aircraft). In fact, the engine regulation setpoint is defined by a differential mode current, whereas the generator regulation setpoint is defined by a common-mode current, which allows dynamic and static interactions between the servo-control of the turbojet engine and the servo-control of the aircraft distribution networks to be avoided. The servo-control module of the turbojet engine adjusts the engine's operating parameters, i.e. the mechanical power transferred between the high-pressure shaft and the low-pressure shaft. Each electrical machine in turn performs the servo-control of the electrical domain by adjusting the supply voltage and/or current of the aircraft's distribution networks.

According to various characteristics of the invention which may be considered alone or in combination:
the servo-control operated by the servo-control module of the turbojet engine is performed in a first frequency bandwidth, referred to as the engine regulation frequency, and the servo-control of the power supply supplying the distribution networks is in a second frequency bandwidth, referred to as the generator regulation frequency, a ratio f₁/f₂ being at least equal to 5;
a low-pass filter is applied to the differential mode current;
each of the generation channels is equipped with an anti-modulation protection device;
the electrical machines are bi-directional DC/AC converters delivering an alternating current voltage to the distribution networks or bi-directional AC/DC converters delivering a DC voltage to the distribution networks;
the system comprises three generation channels associated with each distribution network.

The invention further relates to an aircraft comprising an electrical power generation and distribution system for an aircraft as previously described, the aircraft further comprising electrical storage means.

### BRIEF DESCRIPTION OF THE FIGURES

Further objects and characteristics of the invention will become clearer in the following description, made with reference to the attached figures, wherein:

FIG. 1 is a schematic illustration of an electrical energy generation and distribution system according to one embodiment of the invention. The electrical machines, their regulation electronics and the electrical distribution networks to which they are connected are illustrated;

FIG. 2 is a schematic illustration of the electrical energy generation and distribution system shown in FIG. 1, in which the electrical machines are connected to the regulated electrical distribution network;

FIG. 3 illustrates the principle of servo-controlling the power transferred between the high- and low-pressure shafts, on the one hand, and the electrical supply parameters of the aircraft's distribution networks, on the other.

### DETAILED DESCRIPTION OF THE INVENTION

The invention relates to an electrical power generation and distribution system 1 for use in a hybrid electric propulsion aircraft. In the remainder of this description, this system will be referred to as “system” 1.

The system 1 comprises a turbojet engine 10, which may be a conventional turbojet engine, and preferably a dual-flow turbojet engine. The turbojet engine 10 comprises at least one high-pressure body and at least one low-pressure body, whose thermodynamic coupling and thermodynamic design determine the operating point of the turbojet engine.

The high-pressure body (not shown) comprises a high-pressure compressor, a high-pressure turbine and a high-pressure rotation shaft connecting the high-pressure compressor and the high-pressure turbine. For simplicity's sake, the high-pressure rotation shaft will be referred to as the “high-pressure shaft” in the following. Similarly, the low-pressure body (not shown) comprises a low-pressure compressor, a low-pressure turbine and a low-pressure rotation shaft connecting the low-pressure compressor and the low-pressure turbine. For simplicity's sake, the low-pressure rotation shaft will be referred to as the “low-pressure shaft” in the following. During the various phases of flight, energy is transferred between the low-pressure body and the high-pressure body in order to adapt the operating point of the turbojet engine 10.

The turbojet engine also comprises a combustion chamber, supplied with a flow rate of fuel, the role of which is conventionally to enable the temperature of the air flux from the compressors to be raised by the fuel. In each of the high-pressure and low-pressure bodies, the hot air flux then passes through the turbine in question and is accelerated in an ejection nozzle, by transforming the potential energy of the total pressure and the total temperature into kinetic energy, to enable the aircraft to be propelled. A good thermodynamic design between the high-pressure and low-pressure bodies is therefore necessary to ensure a good level of thrust efficiency by transferring energy into the combustion chamber.

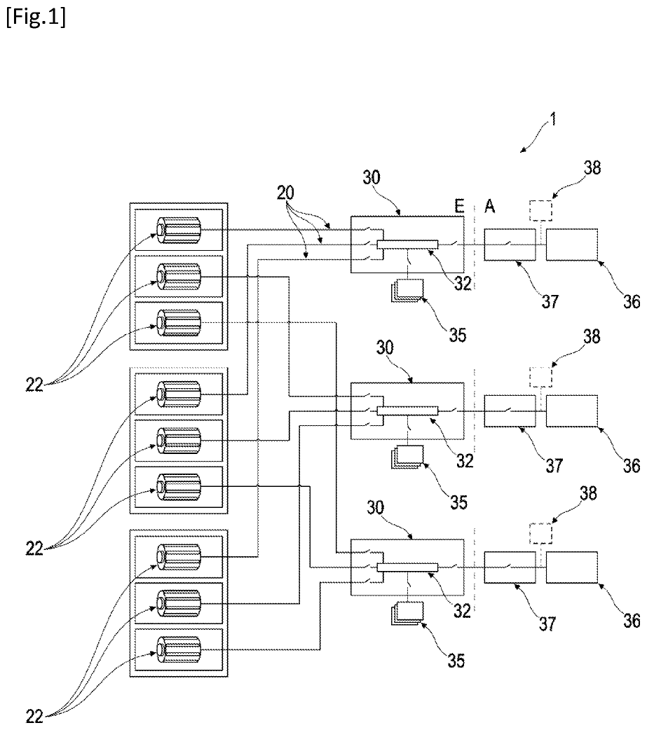

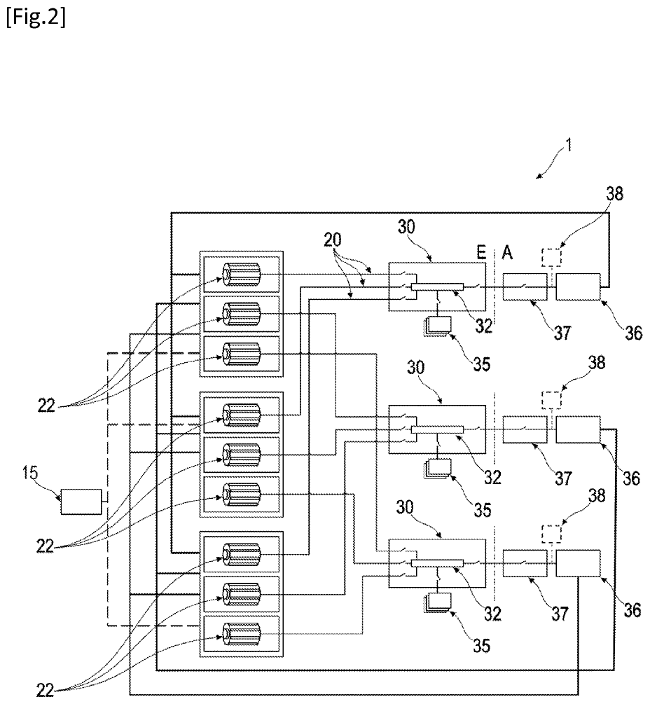

In FIGS. 1 and 2, the reference E, to the left of the dotted line, refers to the engine side, while the reference A, to the right of the dotted line, refers to the aircraft side. On the aircraft side, the system 1 comprises an interconnection and protection module 37 located at the interface between the engine side and the aircraft side, a power supply module 38 and a load 36.

For regulation purposes, the turbojet engine 10 according to the invention comprises a servo-control module 16 capable of regulating the power transferred between the high-pressure body and the low-pressure body of the turbojet engine, in particular between the high-pressure and low-pressure shafts. In practice, the servo-control module 16 of the turbojet engine is part of a regulation device of the turbojet engine 15 (Engine Electronic Control). The turbojet engine servo-control module 16 has as input parameters, on the one hand, the operating parameters Aₖ, k integer, of the high and low pressure shafts and, on the other hand, setpoint parameters, this setpoint being referred to in the following as the “engine regulation setpoint” and noted Cₘ. If the operating parameters Aₖ of the turbojet engine 10 differ from the setpoint parameters, the servo-control module 16 of the turbojet engine corrects and/or amplifies the mechanical power transferred between the high-pressure and low-pressure shafts, in particular by modifying the speed, v, and torque, c, of said shaft(s). This correction and/or amplification of the mechanical power transferred between the high-pressure and low-pressure shafts is carried out by means of an engine operating transfer function F_{t,m}, known as the engine transfer function F_{t,m}. To carry out this regulation, the turbojet engine 10 requires electrical energy.

As mentioned in the preamble to this description, in hybrid electric propulsion aircraft, electrical machines are used to supply the electrical energy required by the electrical system. The electrical energy requirements come from the aircraft's distribution networks 30 and also, as seen in the previous section, from the regulation of the operating parameters of the turbojet engine 10.

At this stage, it can probably be specified that the distribution networks 30 are aircraft electrical networks whose role is to distribute the electrical energy required to supply electrical charge 35, 36 of the aircraft. Of course, the electrical energy requirements of the electrical loads 35, 36 are likely to vary during the different phases of flight, which adds a further difficulty to the management of electrical energy between the different distribution networks 30 and, moreover, the regulation of the engine operating parameters of the turbojet engine 10. The system 1 described in this invention overcomes this problem.

In this respect, the system 1 comprises a plurality of generation channels 20 that can be likened to electrical energy sources. In the context of the invention, these generation channels 20 are used to supply electrical energy to the aircraft's distribution networks 30 and, at the same time, supply the energy required to regulate the turbojet engine's operating parameters. The system 1 comprises at least N distribution networks 30 with N, an integer, greater than or equal to 2. The system also comprises at least M generation channels 20 associated with each distribution network 30, where M is an integer greater than or equal to 1. Several generation channels 20 may be associated with a distribution network 30, but there is always at least one generation channel 20 associated with each distribution network 30, so that the sum of the generation channels 20 in the system 1 is necessarily greater than or equal to N. In the example shown in FIG. 1, three generation channels 20 are associated with each distribution network 30. There are 3*N generation channels, i.e. 9 generation channels 20.

Each generation channel 20 comprises an electrical machine 22. The role of the electrical machines 22 is to convert mechanical power Pₘ drawn from the high and low pressure shafts into electrical power Pₑ. In other words, the electrical machines 22 are converters which, driven by the high-pressure and low-pressure shafts of the turbojet engine, are able to convert the mechanical power thus generated into electrical power. Incidentally, currents are generated at the output of the electrical machines 22 so that each generation channel 20 has a current I_{N,M} flowing through it. It will be understood that the current I_{1,2} corresponds to the current flowing through the second-generation channel 20 associated with the first distribution network 30.

At this stage, it should be noted that several configurations are possible. By way of a non-limiting example, several electrical machines 22 can be connected to each of the shafts. In another non-limiting example, a single electrical machine is connected to each of the shafts. This being the case, each electrical machine can comprise several generation channels 20, in particular independent ones, so as to supply different distribution channels 30. In this respect, each distribution network 30 comprises at least one network 32 of engines connected, on the one hand, to the generation channels 20 associated with the distribution network comprising said network 32 of engines and, on the other hand, to the electrical loads 35, 36. Advantageously, the optimum configuration is determined when the system 1 is designed, taking account of installation constraints.

Each electrical machine 22 also implements a servo-control function of the electrical energy supplied to the distribution networks 30. The servo-control can be applied to the electrical power, voltage or current supplied to the distribution networks 30. The electrical supply parameter of the distribution networks 30 is used to refer to any one of the electrical supply parameters from among the electrical power, voltage or supply current of the distribution networks 30. In this way, the electrical energy delivered to the distribution networks 30 is regulated and compatible with the expected network quality.

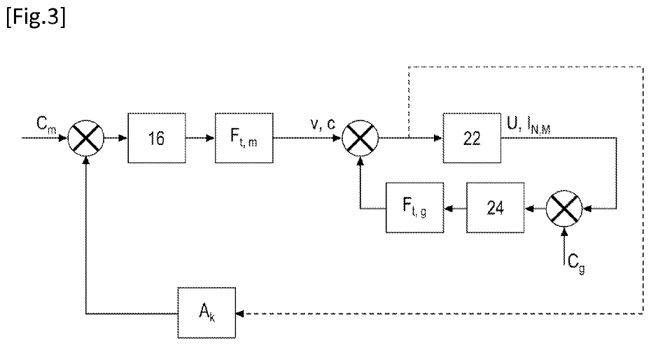

FIG. 3 provides a schematic illustration of how the servo-control of the turbojet engine and that of the power supply parameter(s) of the distribution networks 30 are operated. The regulation of the electrical energy delivered to the distribution networks 30 depends on the one hand on the electrical parameter(s) in the generation channel 20 concerned, namely the voltage and/or current (and therefore the power) in said generation channel, and on the other hand on a generator regulation setpoint Cg. If the voltage and/or current generated in the generation channel 20 differs from the generator regulation setpoint Cg, the electrical machine 22 is able to correct and, if necessary, amplify the parameter(s) concerned. The electrical power consumed varies from one distribution channel 20 to another, so that the generator regulation setpoint C_{g} may vary from one generation channel 20 to another. In this respect, the correction and, where applicable, this amplification is (are) operated by a servo-control module 24 of the electrical machine 22. The servo-control module 24 has as input parameters the voltage U and/or current I_{N,M} generated in the generation channel 20 and the generator regulation setpoint C_{g}. The correction and, if necessary, amplification is achieved by means of a resistive mechanical torque which acts on the speed and torque of the shaft(s). This mechanical resistive torque is associated with an electrical generator transfer function F_{t,g}, referred to as the generator transfer function F_{t,g}.

By way of a non-limiting example, the servo-control of the supply voltage and/or current of the distribution networks 30 can be performed so as to obtain a three-phase alternating current (AC) voltage of 230V. That said, the servo-control can also be set up to obtain a three-phase 115V AC voltage or a DC voltage of 28V or 270V. In any case, it is the electrical machines 22 themselves that are configured to divert this voltage to the distribution networks 30. The voltage is advantageously derived from a hybrid-electric propulsion system of the turbojet engine, the voltage of which can be, for example, 800V.

It should be noted that servo-control of the electrical energy supplying the distribution networks 30 is not compulsory. In this case, the input voltage to distribution networks 30 is nominal. Of course, those skilled in the art will understand that the invention is useful when a servo-control of the supply voltage and/or current of distribution networks 30 is implemented.

In any case, whatever the electrical load condition 35, 36 considered, the electrical power required to maintain the voltage and/or current of the distribution networks 30 translates directly into an electrical power requirement Pₑ from the electrical machines 22 and, consequently, into a mechanical power requirement Pₘ from the high and low pressure shafts. This mechanical power requirement is in addition to the requirements of the turbojet engine 10. Depending on the voltage supplied by the electrical machines 22, the power requirements of the distribution networks 30 can be translated into current requirements.

According to the invention, the engine regulation setpoint Cₘ is defined by a differential mode current I_{d} resulting from the dispatch of power drawn between the different generation channels 20, and, for each distribution network 30, the generator regulation setpoint C_{g} is defined by a common mode current Ie resulting from the currents I_{N,M} generated in the generation channels of said distribution network 30.

As indicated above, the engine regulation setpoint Cₘ is defined by the differential mode current I_{d}. For each distribution network 30, this differential mode current I_{d} corresponds to the current propagating in the opposite direction in the generation channels 20 associated with the distribution network 30 concerned, namely the current flowing from the electrical machines 22 to the distribution network 30 and from said distribution network 30 to the electrical machines 22. Incidentally, the differential mode current I_{d} therefore defines, for each distribution network 30, the dispatch of electrical power between the different generation channels 20 associated with said distribution network 30. It can therefore be used to determine any difference between the mechanical power actually transferred between the high and low pressure shafts and the mechanical power that should be transferred between said high and low pressure shafts for optimum operation of the turbojet engine 10.

It should be remembered that in each generation channel 20, the electric machine 22 is driven, i.e. coupled, either to a high-pressure shaft or to a low-pressure shaft. The mechanical power Pₘ drawn and, subsequently, the electrical power Pₑ generated therefore differ according to the shaft (high or low pressure) to which the electrical machine 22 in question is coupled. Thus, considering the generation channels 20 associated with a given distribution network 30 and from the point of view of the high and low pressure shafts, when the mechanical power requirement is no longer sufficient for the turbojet engine 10 to reach the required operating point, in particular because the mechanical power Pₘ effectively drawn by one/some/all of the electrical machines 22 is too high, the mechanical power effectively transferred between the high and low pressure shafts necessarily deviates from the power that would have to be transferred between said high and low pressure shafts to reach the optimum operating point of the turbojet engine. This difference can be quantified directly by measuring the differential mode current I_{d} in the generation channels 20. The servo-control module 16 of the turbojet engine 10 can, at any time, regulate the power transferred between the high and low pressure shafts according to the engine regulation setpoint Cₘ calculated from the differential mode current I_{d}.

It should be noted that for each distribution network 30, the differential mode setpoint could be determined by measuring the differential voltage existing between the generation channels 20, two by two, associated with this distribution network 30.

Consider the electrical energy generation and distribution system 1 shown in FIG. 2. The differential mode current I_{d} is calculated as follows:

$${I}_{d} = {I}_{11} - {I}_{12} - {I}_{13} = {I}_{21} - {I}_{22} - {I}_{23} = {I}_{31} - {I}_{32} - {I}_{33} \qquad ( 1 )$$

The consequence is that, in each generation channel, the setpoint is calculated as follows:

$${I}_{NM} = \frac{{I}_{N} + {I}_{d}}{3} \qquad ( 2 )$$

For the generation channel M feeding the network 30 of distribution N.

As a non-illustrated example, considering only two generation channels 20 per distribution network 30, the differential mode current I_{d} would become:

$${I}_{d} = {I}_{11} - {I}_{12} = {I}_{21} - {I}_{22} \qquad ( 3 )$$

And in each generation channel, the setpoint is calculated as follows:

$${I}_{NM} = \frac{{I}_{N} + {I}_{d}}{2} \qquad ( 4 )$$

As previously indicated, the generator regulation setpoint C_{g} is defined by the common mode current I_{c}. In particular, for each distribution network 30, the common mode current Ie corresponds to the current propagating in the same direction in the generation channels 20 associated with the distribution network 30 concerned. This common mode current I_{c} is characterised by the sum of the currents supplied by the generation channels 20 associated with said distribution network 30 to this distribution network 30. Consequently, the common mode current I_{c} defines, for each distribution network 30, the electrical power required to supply said distribution network 30. In practice, as seen above, the voltage and/or current required to supply said electrical loads 35, 36 is determined. The common mode current I_{c} is therefore used to determine the generator requirement, and therefore the generator regulation setpoint C_{g}, according to the electrical power actually required to supply the electrical loads 35, 36 of the aircraft via said distribution networks 30.

Consider the electrical energy generation and distribution system 1 shown in FIG. 2. The common mode current I_{c} is calculated as follows:

$${I}_{C} = {I}_{11} + {I}_{12} + {I}_{13} for the network 30 of distribution 1 \qquad ( 5 )$$

$${I}_{C} = {I}_{21} + {I}_{22} + {I}_{23} for the network 30 of distribution 2 \qquad ( 6 )$$

$${I}_{C} = {I}_{31} + {I}_{32} + {I}_{33} for the network 30 of distribution 3 \qquad ( 7 )$$

If the mechanical power drawn from the high-pressure and low-pressure shafts of the turbojet engine is not sufficient to supply the electrical power Pₑ required to supply the/certain distribution networks 30 or one of said distribution networks 30, the electrical machine(s) concerned are able to draw the appropriate mechanical power from the high-pressure and low-pressure shafts, according to the generator setpoint C_{g}, in order to meet this requirement.

As was seen for the differential mode setpoint, the common mode setpoint could also be defined by the average potential at all the generation channels 20 associated with the distribution network 30 concerned instead of the common mode current I_{c}. The average potential corresponds to the average potential difference measured between each of the generation channels 20 and a mass of the system 1.

In this way, the engine regulation setpoint Cₘ and the generator regulation setpoint C_{g} can be determined independently so that the regulation of the power transferred between the high and low pressure shafts by the servo-control module 16 of the turbojet engine, on the one hand, and the regulation of the electrical power supply parameter(s) of the distribution networks 30, on the other hand, can take place without static and dynamic interaction. The two servo-control functions are therefore electrically and physically decoupled, allowing them to be operated by different apparatus. Thus, in steady state, the invention ensures that each of the needs of the distribution networks and the turbojet engine can be met without influencing the others. However, in dynamic operation, it is not possible to have complete independence between the differential mode current I_{d} and the common mode currents I_{c} of each of the distribution networks 30 because of the interactions inherent in the turbojet engine.

Advantageously, the servo-control operated by the servo-control module 16 of the turbojet engine is performed in a first frequency bandwidth f₁, referred to as the engine regulation frequency, and the servo-control of the power supply parameter(s) of the distribution networks 30 is performed in a second frequency bandwidth f₂, referred to as the generator regulation frequency, a ratio f₁/f₂ being at least equal to 5. Thus, any disturbance resulting from an interaction between the servo-control of the power transferred between the high and low pressure shafts on the one hand and the servo-control of one of the supply parameters of the distribution networks 30 on the other hand is purely associated with the transient transfer of energy stored in the system 1. It can therefore be managed by the servo-control apparatus concerned, i.e. the servo-control module 16 of the turbojet engine or the electrical machine(s) 22, and does not lead to dynamic interaction between the different servo-control loops.

It is also advantageous to apply a low-pass filter to the differential mode current I_{d} and, at the same time, to equip each of the generation channels 20 with an anti-modulation protection device. This low-pass filter is implemented on the regulation device 15 of the turbojet engine. The combined use of a low-pass filter on the differential mode current and an anti-modulation protection device on each of the generation channels ensures the correct operation of the system 1 in the event of degradation of the servo-controls operated by the servo-control module 16 of the turbojet engine and one or more of the electrical module(s) 22.

As mentioned above, the electrical machines 22 act as converters. Preferably, the electrical machines 22 are bidirectional DC/AC converters delivering alternating current voltage to the distribution networks 30 or bidirectional AC/DC converters delivering DC voltage to the distribution networks 30. The type of converter is chosen according to the use made of each of the distribution networks 30.

Very advantageously, the invention is applicable to configurations other than those exemplified or illustrated in the figures. The number of distribution networks 30 can be greater than the above examples. In addition, the turbojet engine 10 can comprise a greater number of bodies, and therefore of high-pressure or low-pressure shafts or possibly of intermediate pressure(s), insofar as there is at least one generation channel 20 per distribution network 30 and per stage of the turbojet engine.

1. An electrical power generation and distribution system for a hybrid electric propulsion aircraft, said system comprising:
at least one turbojet engine comprising at least one high-pressure shaft, at least one low-pressure shaft, and a servo-control module capable of regulating a power transferred between the high-pressure shaft and the low-pressure shaft as a function of an engine regulation setpoint (Cₘ),
at least N distribution networks with N an integer greater than or equal to 2, and
at least M generation channels associated with each distribution network, with M being an integer greater than or equal to 1, each generation channel comprising an electrical machine driven by the high or low pressure shaft and capable of converting a mechanical power (Pₘ) drawn from said high or low pressure shaft into an electrical power (Pₑ) so that a current (I_{N,M}) is generated in each of the M generation channels, each of said electrical machines being able to perform the servo-control of a power supply supplying the distribution networks as a function of a generator regulation setpoint (C_{g}),
the electrical power generation and distribution system being wherein the engine regulation setpoint (Cₘ) is defined by a differential mode current (I_{d}) resulting from the dispatch of power drawn between the various generation channels, and, for each distribution network, the generator regulation setpoint (C_{g}) is defined by a common mode current (l_{c}) resulting from the currents (I_{N,M}) generated in the generation channels of said distribution network.

2. The system according to claim 1, wherein the servo-control operated by the servo-control module of the turbojet engine is performed in a first frequency bandwidth (f₁), referred to as the engine regulation frequency, and the servo-control of the power supply supplying the distribution networks is performed in a second frequency bandwidth (f₂), referred to as the generator regulation frequency, a ratio f₁/f₂ being at least equal to 5.

3. The system according to claim 1, wherein a low-pass filter is applied to the differential mode current (I_{d}) and wherein each of the generation channels is equipped with an anti-modulation protection device.

4. The system according to claim 1, wherein the electrical machines are bidirectional DC/AC converters delivering an alternating current voltage to the distribution networks or bidirectional AC/DC converters delivering a DC voltage to the distribution networks.

5. The system according to claim 1, comprising three generation channels associated with each distribution network.

6. An aircraft comprising an electrical power generation and distribution system for an aircraft according to claim 1, the aircraft further comprising electrical storage means.
